(19) United States
(12) Patent Application Publication
(10) Pub. No.: US 2009/0234953 A1
(43) Pub. Date: Sep. 17, 2009

(54) APPARATUS AND METHODS FOR INTEGRATION OF THIRD PARTY VIRTUAL PRIVATE NETWORK SOLUTIONS

(75) Inventor: Igor Braslavsky, San Jose, CA (US)

Correspondence Address: KACVINSKY LLC;4500 BROOKTREE ROAD, SUITE 102, WEXFORD, PA, 15090, US

(73) Assignee: PALM, INC., SUNNYVALE, CA (US)

(21) Appl. No.: 12/045,772

(22) Filed: Mar. 11, 2008

(51) Int. Cl. G06F 15/16

(52) U.S. Cl. 709/227

(57) ABSTRACT

Various embodiments for integration of virtual private network solutions are described. In one embodiment, a mobile computing device may comprise a virtual private network client configured to establish a virtual private network connection over one or more transports and a connection manager. The connection manager may comprise a virtual private network plug-in module associated with the virtual private network client. The connection manager may load the virtual private network plug-in module in response to a request to establish a virtual private network connection using the virtual private network client over a selected transport. The connection manager may instruct the virtual private network plug-in module to send a setup command to the virtual private network client for establishing the virtual private network connection over the selected transport. Other embodiments are described and claimed.

### BACKGROUND

A mobile computing device such as a combination handheld computer and mobile telephone or smart phone generally may provide voice and data communications functionality as well as computing and processing capabilities on various networks. In many cases, the mobile computing device may support a virtual private network (VPN) connection.

VPN solutions provided by third party developers may be integrated within a mobile computing device. It is possible to create a self-contained run-time environment for a VPN client, connected with the native TCP/IP stack via a VPN virtual interface. This self-contained run-time environment isolates the VPN client from details of the operating system (OS), kernel, and TCP/IP stack, but also limits it and requires the VPN client to conform to the run-time model that is defined by this VPN run-time environment.

Accordingly, there exists the need for an apparatus and methods for allowing a VPN client to be closely integrated with the native OS and its TCP/IP stack, while introducing uniform VPN connection management and User Interface across multiple VPN clients and connections.

### BRIEF DESCRIPTION OF THE DRAWINGS

FIG. 1 illustrates one embodiment of a mobile computing device.

FIG. 2 illustrates one embodiment of a data networking architecture.

FIGS. 3A-3E illustrate exemplary user interfaces.

FIGS. 4A-4D illustrate exemplary user interfaces.

FIG. 5 illustrates one embodiment of a logic diagram.

### DETAILED DESCRIPTION

Various embodiments for integration of virtual private network (VPN) solutions are described. In one embodiment, a mobile computing device may comprise a virtual private network client configured to establish a virtual private network connection over one or more transports and a connection manager. The connection manager may comprise a virtual private network plug-in module associated with the virtual private network client. The connection manager may load the virtual private network plug-in module in response to a request to establish a virtual private network connection using the virtual private network client over a selected transport. The connection manager may instruct the virtual private network plug-in module to send a setup command to the virtual private network client for establishing the virtual private network connection over the selected transport. Other embodiments are described and claimed

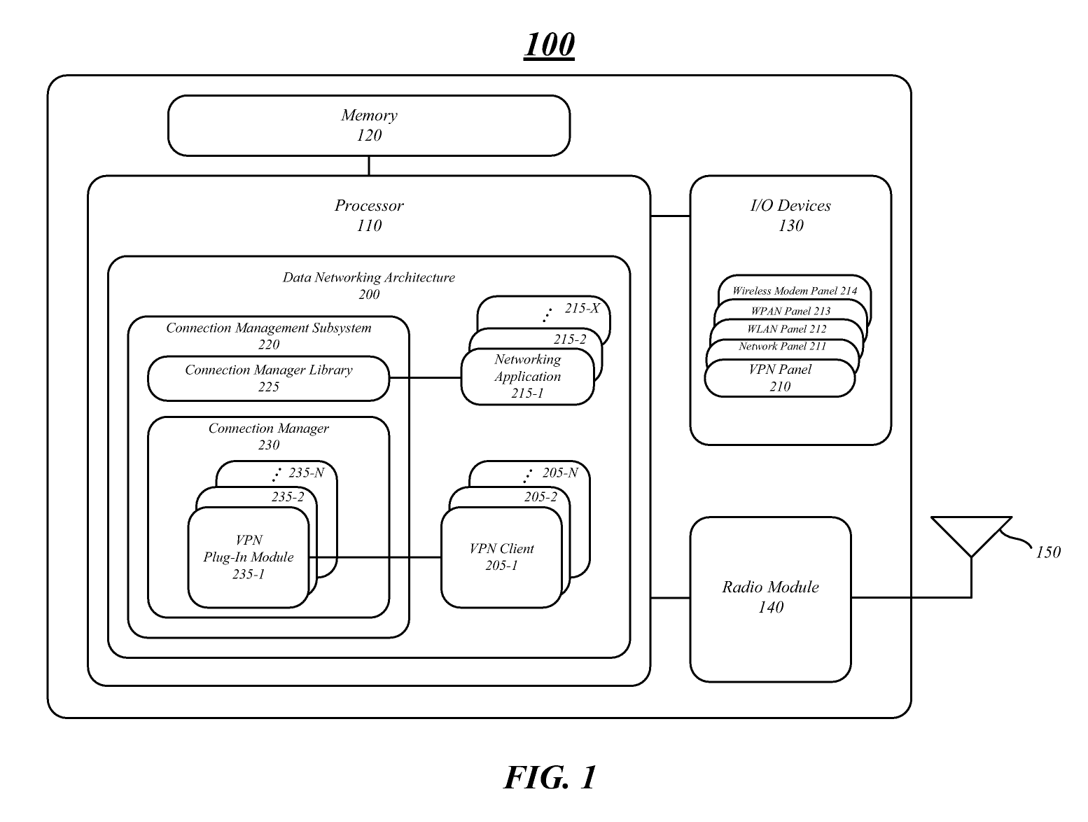

FIG. 1 illustrates a mobile computing device 100 suitable for implementing various embodiments. The mobile computing device 100 may be implemented as a combination handheld computer and mobile telephone, sometimes referred to as a smart phone. Examples of smart phones include, for example, Palm® products such as Palm® Treo™ smart phones. Although some embodiments may be described with the mobile computing device 100 implemented as a smart phone by way of example, it may be appreciated that the mobile computing device 100 may be implemented as other types of user equipment (UE) or wireless computing devices having voice and/or data communications functionality such as a handheld device, personal digital assistant (PDA), mobile telephone, combination mobile telephone/PDA, mobile unit, subscriber station, game device, messaging device, media player, pager, or any other suitable communications device in accordance with the described embodiments.

The mobile computing device 100 generally may be configured to support or provide cellular voice communication, wireless data communication, and computing capabilities. For example, the mobile computing device 100 may provide voice and wireless data communication functionality by communicating a mobile network such as a Code Division Multiple Access (CDMA) network, Global System for Mobile Communications (GSM) network, North American Digital Cellular (NADC) network, Time Division Multiple Access (TDMA) network, Extended-TDMA (E-TDMA) network, Narrowband Advanced Mobile Phone Service (NAMPS) network, third generation (3G) network such as a Wide-band CDMA (WCDMA) network, CDMA-2000 network, Universal Mobile Telephone System (UMTS) network, and others.

The mobile computing device 100 may support voice communications services as well as wireless wide area network (WWAN) data communications services including Internet access. Examples of WWAN data communications services supported by the mobile computing device 100 may include Evolution-Data Optimized or Evolution-Data only (EV-DO), Evolution For Data and Voice (EV-DV), CDMA/1xRTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others.

The mobile computing device 100 may provide wireless local area network (WLAN) data communications functionality in accordance with the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and others.

The mobile computing device 100 also may be arranged to perform data communications functionality in accordance with shorter range wireless networks, such as a wireless personal area network (PAN) offering Bluetooth® data communications services in accordance with the Bluetooth® Special Interest Group (SIG) series of protocols, specifications, profiles, and so forth. Other examples of shorter range wireless networks may employ infrared (IR) techniques or near-field communication techniques and protocols, such as electromagnetic induction (EMI) techniques including passive or active radio-frequency identification (RFID) protocols and devices.

As shown in FIG. 1, the mobile computing device 100 may comprise by way of example a processor 110, a memory 120, input/output (I/O) devices 130, a radio module 140, and an antenna system 150. These elements or portions of these elements may be implemented in hardware, software, firmware, or in any combination thereof. Although FIG. 1 includes a limited number of elements for purposes of illustration, it can be appreciated that the mobile computing device 100 may include other elements in accordance with the described embodiments.

The processor 110 may comprise a general purpose processor or an application specific processor arranged to provide general or specific computing capabilities for the mobile computing device 100. In some implementations, the mobile computing device 100 may comprise a dual processor architecture including a host processor and a radio processor arranged to communicate with each other using interfaces such as one or more universal serial bus (USB) interfaces, micro-USB interfaces, universal asynchronous receiver-transmitter (UART) interfaces, general purpose input/output (GPIO) interfaces, control/status lines, control/data lines, audio lines, and so forth. It may be appreciated that the mobile computing device 100 may use any suitable number of processors in accordance with the described embodiments.

The memory 120 may comprise computer-readable media such as volatile or non-volatile memory units arranged to store programs and data for execution and/or use by the mobile computing device. For example, the memory 120 may store executable program instructions, code or data capable of being retrieved and executed by the processor 110 to provide operations for the mobile computing device 100. The memory 120 also may implement various databases and/or other types of data structures (e.g., arrays, files, tables, records) for storing data for use by the processor 110 and/or other elements of the mobile computing device 100.

The I/O devices 130 may comprise various devices for receiving input from and displaying content to a user of the mobile computing device such as a display and a keypad, for example. The keypad may be implemented by an alphanumeric keypad having a QWERTY key layout and an integrated number dial pad. The keypad may comprise a physical keypad and/or a virtual keypad using soft buttons displayed on the display. The display may be implemented by a liquid crystal display (LCD) such as a touch-sensitive, color, thin-film transistor (TFT) LCD or other type of suitable visual interface for displaying content to a user of the mobile computing device 100. The mobile computing device 100 may comprise various other I/O devices 130 including keys (e.g., input keys, preset and programmable hot keys), buttons (e.g., left and right action buttons, a multidirectional navigation button, phone/send and power/end buttons, preset and programmable shortcut buttons), switches (e.g., volume rocker switch, a ringer on/off switch having a vibrate mode), a microphone, speakers, an audio headset, a camera, a stylus, and so forth.

The radio module 140 may comprise various radio elements, including a radio processor, one or more transceivers, amplifiers, filters, switches, and so forth. The radio module 140 may be arranged to provide voice and/or data communications functionality in accordance with different types of wireless network systems or protocols. In various embodiments, the radio module 140 may comprise one or more transceivers arranged to support voice and/or data communications for the wireless network systems or protocols as previously described. For example, the radio module 140 may comprise one or more transceivers supporting voice communication (e.g., CDMA, GSM, UMTS), WWAN data communication (e.g., EVDO, EVDV, CDMA/1xRTT, GSM/GPRS, EDGE, HSDPA), WLAN data communication (e.g., WiFi, WiMAX), and/or WPAN data communication (e.g., Infrared protocols, Bluetooth®, IR, EMI) in accordance with the described embodiments. It may be appreciated that the radio module 140 may utilize different communications elements (e.g., radio processors, transceivers, etc.) to implement different communications techniques.

The antenna system 150 may comprise or be implemented as one or more internal antennas and/or external antennas for transmitting and receiving electrical signals. In some embodiments, the antenna system 150 may support operation of the mobile computing device 100 in multiple frequency bands or sub-bands such as the 2.4 GHz range of the ISM frequency band for WiFi and Bluetooth® communications, one or more of the 850 MHz, 900 MHZ, 1800 MHz, and 1900 MHz frequency bands for GSM, CDMA, TDMA, NAMPS, cellular, and/or PCS communications, the 2100 MHz frequency band for CDMA2000/EV-DO and/or WCDMA/UMTS communications, the 1575 MHz frequency band for Global Positioning System (GPS) operations, and others.

In general, the processor 110 may perform operations associated with higher layer protocols and applications. User applications generally may provide user interfaces (UIs) to communicate information between the mobile computing device 100 and a user. Application programs may comprise upper layer programs running on top of the operating system (OS) of the processor 110 that operate in conjunction with the functions and protocols of lower layers including, for example, a transport layer such as a Transmission Control Protocol (TCP) layer, a network layer such as an Internet Protocol (IP) layer, and a link layer such as a Point-to-Point (PPP) layer used to translate and format data for communication.

The processor 110 may provide various user applications, such as messaging applications, web browsing applications, Virtual Private Network (VPN) applications, personal information management (PIM) applications (e.g., contacts, calendar, scheduling, tasks), word processing applications, spreadsheet applications, database applications, media applications (e.g., video player, audio player, multimedia player, digital camera, video camera, media management), location based services (LBS) applications, gaming applications, and so forth. Examples of messaging applications may include without limitation a cellular telephone application, a voicemail application, a Voice-over-Internet Protocol (VoIP) application, a facsimile application, an e-mail application, a short message service (SMS) application, a multimedia message service (MMS) application, a video teleconferencing application, a push-to-talk (PTT) application, a push-to-video application, Text-to-Speech (TTS) application, an instant messaging (IM) application, and so forth. It is to be appreciated that the mobile computing device 100 may implement other types of applications in accordance with the described embodiments.

The processor 110 also may provide functional utilities that are available to various protocols, operations, and/or applications. Examples of such utilities include operating systems (e.g., proprietary OS, open source OS, hybrid OS), device drivers, programming tools, utility programs, software libraries, application programming interfaces (APIs), and so forth. Exemplary operating systems may include, for example, a Palm OS®, Palm OS® Cobalt, Microsoft® Windows OS, Microsoft Windows® CE OS, Microsoft Pocket PC OS, Microsoft Mobile OS, Symbian OS™, Embedix OS, Linux OS, Binary Run-time Environment for Wireless (BREW) OS, JavaOS, a Wireless Application Protocol (WAP) OS, or other suitable OS in accordance with the described embodiments. The mobile computing device 100 may comprise other system programs such as device drivers, programming tools, utility programs, software libraries, application programming interfaces (APIs), and so forth.

As shown in FIG. 1, the mobile computing device 100 may comprise or implement a data networking architecture 200 that may be structured and arranged to support simultaneous data networking over multiple transports. The data networking architecture 200 may manage simultaneous data networking connections such TCP/IP-based networking over various transports such as a WAN (e.g., UMTS, EvDO), a WLAN (e.g., WiFi), a WPAN (e.g., Bluetooth®), USB, and so forth.

Each transport may be implemented as a set of hardware, firmware and/or software that provides access to some network using a physical transport media. Some transports may allow only one connected network session at a time, while other transports may allow several simultaneously connected network sessions. Each network session may comprise a logical session between the mobile computing device 100 and a network over an enabled transport, for the purpose of sending and receiving TCP/IP traffic. When a network session is connected, relevant IP parameters specific to that network session are obtained such that the network session is up at physical, data link and network layers and is ready to transmit and receive application level data.

As shown, the data networking architecture 200 may comprise multiple VPN clients such as VPN clients 205-1 through 205-N, where N may represent any suitable positive integer value in accordance with the described embodiments. In various embodiments, the data networking architecture 200 may support a VPN framework for integration of Internet Protocol Security (IPSec), Point-to-Point Tunneling Protocol (PPTP) and other VPN solutions provided by third party developers with respect to the provider of the mobile computing device 100.

The VPN framework may support the installation of multiple VPN clients 205-1 through 205-N and enable multiple configurations to be created for each VPN client. For example, a particular VPN client (e.g., VPN client 205-1) may be configured to operate over a WiFi or WAN transport. The VPN framework also may allow a plurality of the VPN clients 205-1 through 205-N to run simultaneously over different network connections. For instance multiple simultaneously connected VPN configurations may be enabled over WAN and WiFi at the same time. In addition, the VPN framework may support an auto-connection mechanism for the VPN clients 205-1 through 205-N.

In various implementations, the VPN framework may provide a pluggable user interface (UI) model for integration of the VPN clients 205-1 through 205-N when provided by various third party developers. The VPN framework may allow third party VPN client developers to effectively integrate configuration UIs, connection progress dialogs, and connectivity management within the mobile computing device 100. Accordingly, the native implementation (e.g., Linux based implementation) for each of the VPN clients 205-1 through 205 may remain almost entirely unchanged.

The user of the mobile computing device 100 may be presented with a VPN panel 210 for displaying and configuring VPN network preferences for one or more of the VPN clients 205-1 through 205-N. The VPN panel 210 may display various configuration UIs to allow a user to set up and configure a VPN account for a particular VPN client (e.g., VPN client 205-1). The user may view, input, and modify VPN configuration information (e.g., user name, password, VPN group name, VPN password) using I/O devices 130 such as a keyboard and display.

When multiple VPN clients are installed, the user may select a particular VPN client (e.g., VPN client 205-1) via the VPN panel 210 and may add or edit a VPN account for the selected VPN client. The user may then add, modify, or delete VPN configuration information which then may be saved as a configuration profile for the VPN account.

The VPN panel 210 may allow the user of the mobile computing device 100 to associate a given VPN configuration with a particular transport. If the mobile computing device 100 supports multiple transports (e.g., WAN and WiFi), the user may pick the transport over which the selected VPN configuration will be established. For example, the user can specify whether a VPN connection will be established over a WLAN transport (e.g., WiFi) or over a WAN transport (e.g., UMTS, EvDO).

Once a VPN client is configured, the VPN panel 210 may display a VPN connection UI including a connect button for establishing a VPN connection. While the connection to a particular VPN client (e.g., VPN client 205-1) is proceeding in the foreground, a series of progress dialogs may be displayed via the VPN panel 210, and user cancellation and/or other events may be monitored.

In addition to the VPN panel 210, the user of the mobile computing device 100 may be presented with various other communications panels (e.g., UIs) for displaying and configuring data networking communications. As shown, the mobile computing device 100 may present a network panel 211 for displaying and configuring WAN networking preferences, a WLAN panel 212 for displaying and configuring WLAN (e.g., WiFi) networking preferences, a WPAN panel 213 for displaying and configuring WPAN (e.g., Bluetooth®) networking preferences, and a wireless modem panel 214 for configuring the mobile computing device 100 to be set-up as a modem or gateway between a connected computer and a mobile network.

The wireless modem may allow on-device networking applications to communicate with software on the connected computer and/or to share a WAN or a local (e.g., USB or Bluetooth®) connection. For example, the mobile computing device 100 may manage a WAN connection between the mobile computing device 100 and the mobile network to provide Internet Connection Sharing (ICS) between applications (e.g., MMS, browsing, and background e-mail) running on the mobile computing device 100 and data traffic coming through the mobile computing device 100 on other interfaces. The wireless modem also may manage a local connection (e.g., USB or Bluetooth®) between the mobile computing device 100 and the connected computer to support out-of-band data connection enabling on-device networking applications to share the local connection.

The VPN panel 210 as well as the other communications panels may be accessible from a preferences application. The VPN panel 210 also may be launched by various networking applications such as network applications 215-1 through 215-X, where X may represent any suitable positive integer value in accordance with the described embodiments. For example, an e-mail application and/or a browser application may indicate whether a VPN is connected or not and may include a menu item that when selected launches the VPN Panel 210. The VPN framework may support VPN connectivity for each of the network applications 215-1 through 215-X regardless of whether such networking applications use the proprietary OS (e.g., PalmOS) of the mobile computing device 100, a native open-source OS (e.g., Linux OS), and/or a hybrid OS platform that uses a proprietary OS (e.g., PalmOS) for UI and other non-networking related tasks and an open-source OS (e.g., Linux OS) for networking related tasks.

As shown, the data networking architecture 200 may comprise a connection management subsystem 220. The connection management subsystem 220 may support simultaneous data networking and may be arranged to configure data networking, control the state of network transports, and retrieve status and diagnostic information. In various embodiments, the connection management subsystem 220 may operate in conjunction with or as part of the VPN framework to enable integration of VPN clients 205-1 through 205-N, which may be provided by one or more third party developers. For example, the connection management subsystem 220 may support multiple simultaneous network sessions for the VPN clients 205-1 through 205-N and may integrate with the VPN panel 210 for displaying networking configuration UIs, VPN connection UIs, and progress dialogs.

The connection management subsystem 220 may include a connection manager library 225 and a connection manager 230. The connection manager library 225 may comprise an API defining a set rules and guidelines for enabling internal and external application developers to either port or develop data networking applications for the mobile computing device 100. For example, the connection manager library 225 may provide a programming model for initiation and termination of network connections, registration for notifications, reaction to connectivity failures, and so forth.

The connection manager library 225 may provide an API defining the way applications and other transports interact with the connection manager 230. In various embodiments, the connection manager library 225 may include a VPN API comprising a set of VPN related functions. The VPN API may define various functions and calls for interacting with the VPN clients 205-1 through 205-N such as to send configuration information, query for status information, start, stop, and so forth. The VPN API may provide a mechanism to get and set various parameters for the VPN clients 205-1 through 205-N and notifications to inform networking applications when a particular VPN session gets connected or disconnected. In some cases, networking applications may be able to control VPN connectivity via the VPN API, find out whether a VPN is currently connected or disconnected via API calls, and/or register to receive VPN up or down notifications when VPN sessions change states.

The connection manager 230 may provide centralized data networking connectivity management for the mobile computing device 100. In various embodiments, the connection manager 230 may be implemented as a daemon (e.g., Linux daemon) that runs in the background and controls VPN connectivity as well as other data networking connectivity (e.g., cellular, WAN, WLAN, WPAN, USB, etc.) for the mobile computing device 100. The connection manager 230 may provide a pluggable framework so that multiple VPN clients 205-1 through 205-N can co-exist on the system. The connection manager 230 may receive various connection requests, identify an appropriate transport, determine whether a new network session must be initiated and whether to display progress UI, and receive relevant connection status changes from the VPN clients 205-1 through 205-N as well as other transports.

In various embodiments, the connection manager 230 may operate in conjunction with or as part of the VPN framework to enable integration of the third party VPN clients 205-1 through 205-N. For example, each of the VPN clients 205-1 through 205-N may be arranged to conform to the interaction model of the connection manager 230 and to interact with connection manager 230 for the purpose of initiating and terminating VPN connections over specific transport interfaces and updating the connection manager 230 with status information that may be conveyed to networking applications via connection manager VPN deferred notifications.

As shown, the connection manager 230 may comprise multiple VPN plug-in modules 235-1 through 235-N associated with respective VPN clients 205-1 through 205-N. Each of the VPN plug-in modules 235-1 through 235-N provides a run-time pluggable front-end for the corresponding VPN clients 205-1 through 205-N. The VPN plug-in modules 235-1 through 235-N may conform to the API set provided by the connection manager 230.

The VPN plug-in modules 235-1 through 235-N may be implemented as library plug-in conforming to the run-time interaction model specified by the connection manager 230. In various embodiments, a VPN plug-in module (e.g., VPN plug-in module 235-1) may comprise a prc file provided by the third party developer containing all the configuration forms (e.g., UIs) for a corresponding VPN client (e.g., VPN client 205-1). The VPN plug-in modules 235-1 through 235-N may manage and implement an abstraction layer for the VPN clients 205-1 through 205-N. The VPN plug-in modules 235-1 through 235-N may abstract interfaces specific to each of the VPN clients 205-1 through 205-N. Each VPN plug-in module (e.g., VPN plug-in module 235-1) may be used to abstract an interface to a specific VPN client (e.g., VPN client 205-1).

Each of the VPN plug-in modules 235-1 may be installed so that the connection manager 2230 can locate and link with it in response to receiving a request for a VPN connection. For example, the VPN plug-in modules may comprise plug-in libraries stored in a directory known to the connection manager 230. The connection manager 220 may detect and initialize compatible third party VPN plug-in libraries.

When provided by third party developers, each of the VPN clients 205-1 through 205-N is free to continue with its native platform implementation (e.g., Linux based implementation) and is not limited by an artificial run-time environment. Each of the VPN plug-in modules 235-1 through 235-N will be developed by the same third party developer that provided the corresponding VPN clients 205-1 through 205-N. Accordingly, each VPN plug-in modules (e.g. VPN plug-in module 235-1) will know how to interact with its corresponding VPN client (e.g., VPN client 205-1). Different third party developers can provide their own VPN clients, and the user can choose among various installed VPN clients.

In various embodiments, each of the VPN plug-in modules 235-1 through 235-N may implement a uniformly defined transport plug-in API for communicating with the connection manager 230. The transport plug-in API may define initialize, finalize, and control calls. In the event that the VPN plug-in modules 235-1 through 235-N need to convey asynchronous information to the connection manager 230 that cannot be returned in the context of initialize, finalize or control API calls, the VPN plug-in modules 235-1 through 235-N may convey asynchronous information via the API provided by the connection manager library 225. The connection manager library 225 also may allow messages from the VPN clients 205-1 through 205-N to be directed to their respective VPN plug-in modules 235-1 through 235-N.

In some cases, a shim layer may be provided between the core VPN client (e.g., VPN client 205-1) and its VPN plug-in (VPN plug-in module 235-1). The shim layer may implement a middle translation layer for translating requests from a particular VPN plug-in module (e.g., VPN plug-in module 235-1) for a vendor specific interface. For example, a third party VPN client may have a native vendor specific interface for requesting connection, disconnection, status information, and updates, which requires translation by the shim layer.

The VPN plug-in modules 235-1 through 235-N may enable a user to set up VPN accounts and/or establish a VPN connection. For example, the user may use a browser to establish an Internet connection and then go to the preferences application which presents the VPN panel 210. The VPN panel 210 may be used to launch a VPN plug-in, make the necessary configuration, and save the file to a database.

To set up a VPN account for a particular a VPN client (e.g., VPN client 205-1), the VPN panel 210 may launch a particular VPN plug-in module (e.g., VPN plug-in module 235-1) for the particular VPN client (e.g., VPN client 205-1) to allow the user to set up and configure a VPN account. The VPN panel 210 may display a configuration UI requesting user name, password, VPN group name, VPN password, etc. When the configuration data has been received, the particular VPN client (e.g., VPN client 205-1) may save the data as a configuration profile for the VPN account into the VPN database. The configuration UI may or may not be centralized, and VPN client configuration data may pass through the connection manager 230 between client-specific modules.

When multiple VPN accounts have been established, the VPN panel 210 may be configured to work with multiple VPN plug-in modules 235-1 through 235-N by sending launch commands. The VPN panel 210 can send launch codes to determine the number of VPN accounts that are set up and/or which accounts are active.

After configuration, the user may attempt to establish a VPN connection using a VPN menu item in an application such as browser and/or by selecting a Connect VPN button on the VPN panel 210. When the Connect VPN button is clicked, for example, the VPN panel 210 may send a VPN connection request which is received by the connection manager library 225 and passed to the connection manager 230. The connection manager may identify which VPN client configuration and transport were selected by the VPN panel 210. The connection manager 230 may then locate the appropriate VPN plug-in library associated with the configuration profile, load it, call its Init function, and instruct it to send a setup connection command to the corresponding VPN client. The VPN plug-in module and its respective VPN client may then establish the VPN connection over the selected transport.

In some embodiments, the connection manager 230 may bring up the transport first and then instruct the VPN plug-in module to establish a VPN connection over the transport. For example, if a VPN configuration profile indicates that a VPN connection should occur over WiFi, the connection manager 230 can bring up a WiFi connection and tell the VPN plug-in to connect over the WiFi connection. When an application requests a VPN connection or when the user inputs a command to establish a VPN connection using the VPN panel 210, the connection manger 230 would first bring up the WiFi connection and then the VPN plug-in would ask the VPN client that is configured to connect over that WiFi connection.

When VPN establishment is complete, the VPN client may inform the connection manager 230 of the successful connection, and a VPN up deferred notification would be issued. In addition, a notification may be sent to all applications that are registered to receive notification whether the VPN connection is up or down. If the connection manager 230 is informed that a VPN session is down, the connection manager 230 may de-Init the corresponding VPN plug-in, and VPN down notification will be broadcast.

In general, the details of the communication between the VPN plug-in modules 235-1 through 235-N and their respective VPN clients 205-1 through 205-N are transparent to the connection manager 230. The connection manager 230 does not need to know about transport specific details. Accordingly, the connection manager 230 may remain agnostic to the nature of a give VPN solution.

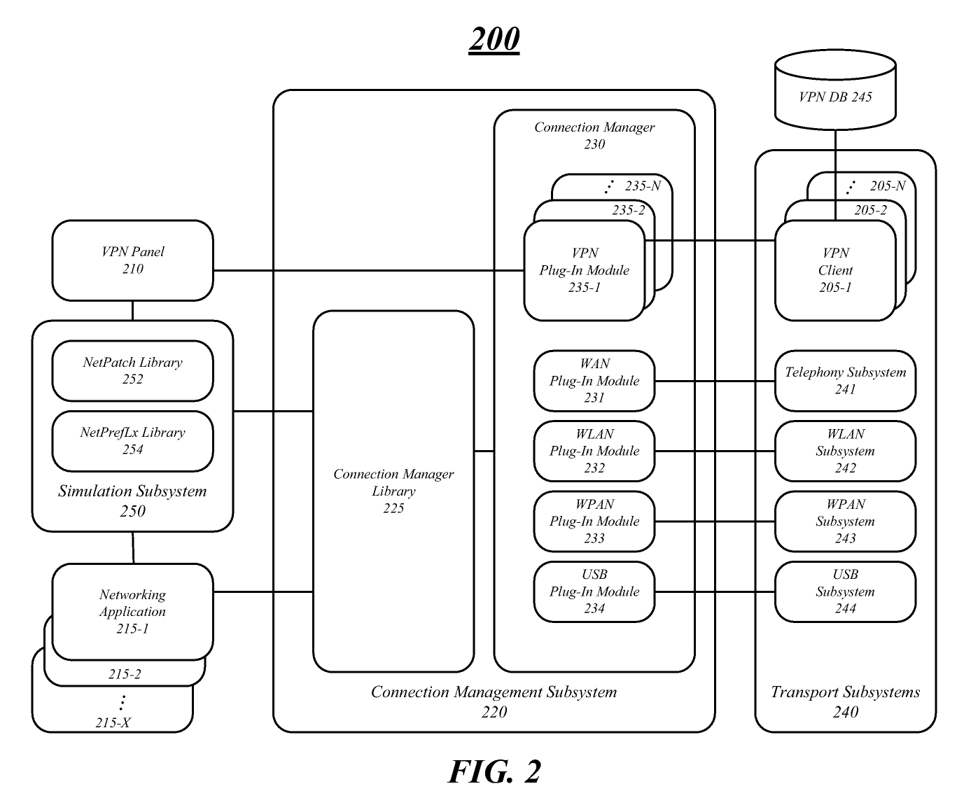

FIG. 2 illustrates a data networking architecture 200 suitable for implementing various embodiments. As shown the data networking architecture 200 includes connection manager 230 comprising VPN plug-in modules 235-1 through 235-N and respective VPN clients 205-1 through 205-N implemented by the transport subsystems 240. The VPN clients 205-1 through 205-N may be arranged to store configuration profiles in VPN database 245.

In this embodiment, the connection manager 230 may be implemented as a daemon (e.g., Linux daemon) that controls all the connectivity (e.g., cellular, WAN, WLAN, WPAN, USB, etc.) for the mobile computing device 100. The connection manager 230 may communicate with various networking transport subsystems 240 through respective transport plug-in modules. Each of the transport plug-in modules may comprise a plug-in library such as a Linux shared library. The libraries may be placed in a location that the connection manager 230 will scan during start-up. The connection manager 230 may load and dynamically link with each library it finds.

As shown, the connection manager 230 may comprise a WAN plug-in module 231 to inter-work with a telephony subsystem 241 to establish WAN network sessions. The connection manager 230 may comprise a WLAN plug-in module 232 to inter-work with WLAN subsystem 242 to establish WLAN network sessions. The connection manager 230 may comprise a WPAN plug-in module 233 to inter-work with WPAN subsystem 243 to establish WPAN network sessions. The connection manager 230 may comprise a USB plug-in module 234 to inter-work with USB subsystem 244 to establish USB network sessions.

In various embodiments, the underlying OS platform for the data networking architecture 200 may be an open source OS such as Linux. In such embodiments, the data networking architecture 200 may use various Linux core networking components. For example, the connection management subsystem 220, the transport subsystems 240, and some data networking applications 215-1 through 215-X may use Linux core networking components, such as the TCP/IP stack, PPP, DHCP, DNS, NAT, routing, diagnostic tools, administrative tools, and others.

Linux is a multi-process, multi-threaded system with virtual memory per process and clear distinction between user and kernel space. Threads within the same process run at an equal priority and share virtual memory allocated to that process. The components of the data networking architecture 200 will run in user space. Some of these components will run in Palm Arcane Run-Time System (PARTS) process, some will run in connection manager process. The networking configuration panels including the VPN panel 210 and others, the connection manager library 225, the NetPatch Library 252 and the Palm Net Linux Library 254 run in PARTS Process. The connection manager 230, the VPN Plug-in modules (libraries) 235-1 through 235-N, and the transport plug-in modules (WAN, WiFi, Bluetooth, USB) and run in the connection manager process.

The connection management subsystem 220 may rely on Linux Policy Routing mechanisms to set up rules to control routing of packets originating from the mobile computing device 100 or those passing through when the wireless modem is connected. In various embodiments, the WAN plug-in module 231 will inter-work with Linux native PPP client for communication with the WAN radio. In case of UMTS multiple simultaneously connected PDP contexts, a separate PPP client connection may be made between the host and the WAN radio. The WAN plug-in 231 may support multiple access point name (APN) connections simultaneously or one-APN-at-a-time depending on the carrier. The telephony subsystem 241 may use PPP as the data-link layer for WAN networking connectivity with GSM and CDMA radios.

The WLAN subsystem 242 may use the Linux DHCP Client for WiFi transport when it is connecting or connected in infrastructure mode to an Access Point or when it is joining a stand-alone Ad-Hoc Network (i.e. Ad-Hoc Network is not involved in providing wireless modem connection). When joining an Ad-Hoc network, the WLAN subsystem 242 may rely first on DHCP Client functionality to obtain the IP parameters for the network session. If this fails, the WLAN subsystem 242 may fall back to Linux Auto-IP Configuration, where it will assign itself an IP address. The WPAN subsystem 243 may use the Linux DHCP Server for transport when joining a Bluetooth® PAN involved in providing wireless modem connection.

The data networking architecture 200 may support compatibility with non-Linux based applications such as PalmOS (e.g., 68K and ARM PalmOS) data networking applications. The data networking architecture 200 may comprise a simulation subsystem 240 to provide compatibility for PalmOS data networking applications so that such application work with Linux-based VPN clients 205-1 through 205-N. In general, the simulation subsystem 240 may allow the data networking applications (e.g., 68K and ARM PalmOS) to execute in a proprietary OS (e.g., PalmOS) emulation environment, called Palm Arcane Run-Time System (PARTS). The simulation subsystem 250 may comprise a NetPatch library 252 for translating PalmOS calls from data networking applications into Linux networking calls and a NetPrefLx library 254 comprising the Linux implementation of the API calls.

The simulation subsystem 250 and the connection management subsystems 220 may interface with a number of external Palm-made and native Linux subsystems. Linux Sockets API may be used for user data communication and for inter-process communication between the simulation subsystem 250 and the connection management subsystem 220. The simulation subsystem 250 and the connection management subsystem 220 may communicate with various native Linux networking components (PPP, DHCP, NAT, routing) via interfaces provided by the components, administrative scripts or administrative networking commands provided by the system.

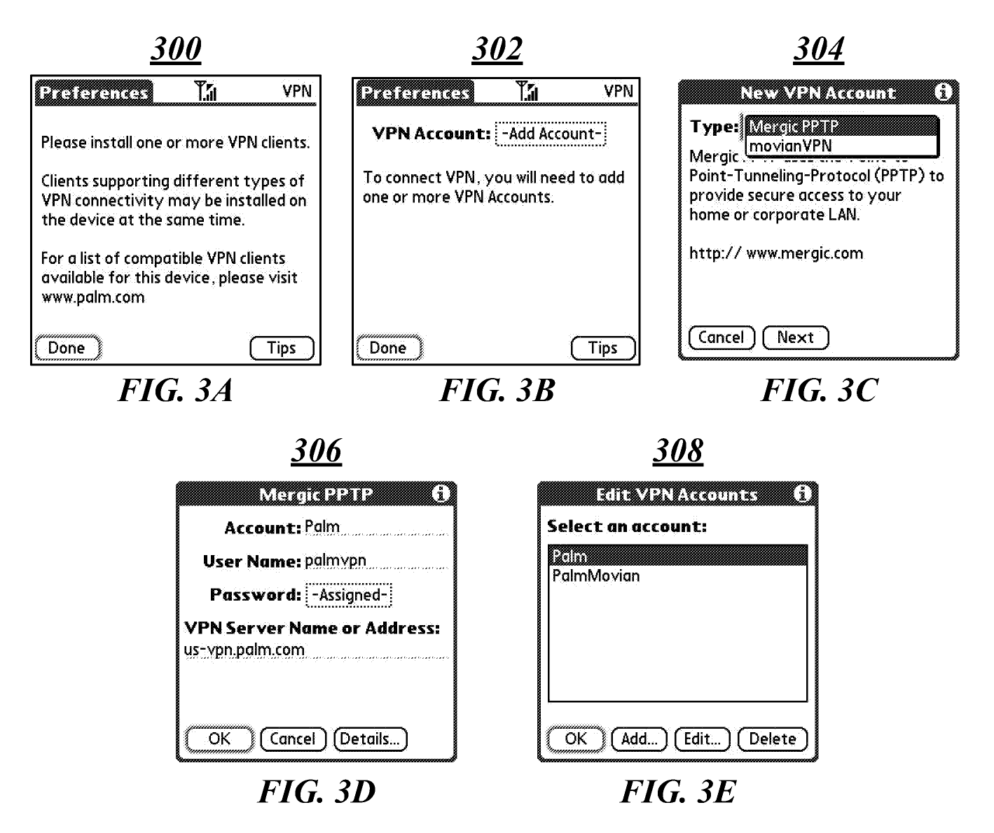

FIGS. 3A-3E illustrate various UIs which may be implemented by the VPN panel 210 of the mobile computing device 100. As shown in FIG. 3A, a UI 300 may be presented by the VPN panel 210 when there are no VPN clients on the mobile computing device 100, the WAN radio is on, but not connected, and the WiFi radio is disabled. As shown in FIG. 3B, a UI 302 may be presented by the VPN panel 210 when one or more VPN clients are installed, but none are configured.

As shown in FIG. 3C, a UI 304 may be presented by the VPN panel 210 when the user taps on Add Account, there is more than one VPN client installed, and the user is given a way to select which VPN client to configure. As shown in FIG. 3D, a UI 306 may be presented by the VPN panel 210 to configure a specific VPN client (e.g., Mergic PPTP client). As shown in FIG. 3E, a UI 308 may be presented by the VPN panel to edit (e.g., add, modify or delete VPN configurations) a VPN account when one or more VPN configurations are created, and the user accesses the UI 308 from a VPN Account selector.

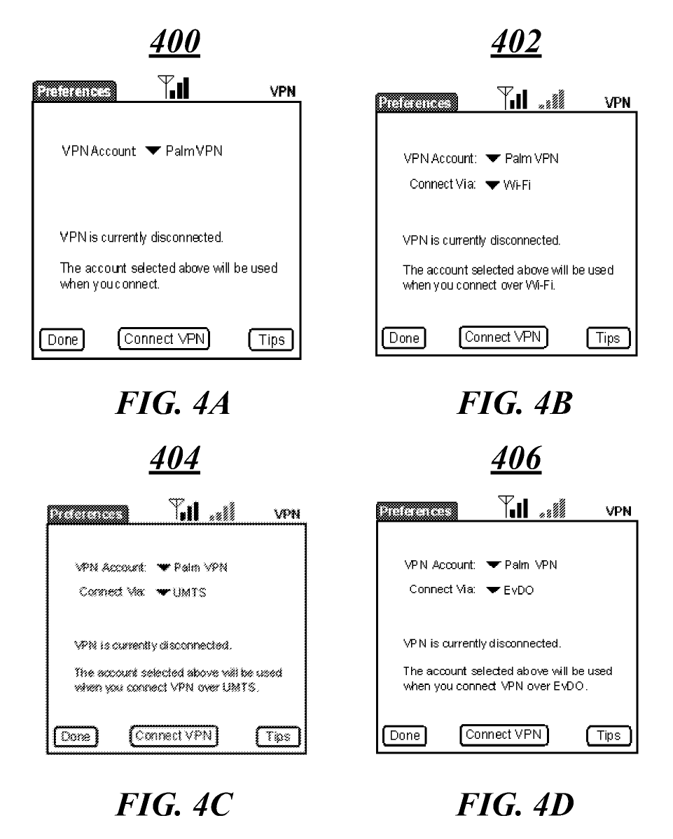

FIGS. 4A-4D illustrate various UIs which may be implemented by the VPN panel 210 of the mobile computing device 100. As shown in FIG. 4A, a UI 400 may be presented by the VPN panel 210 for a mobile computing device 100 without WiFi or WAN hardware. As shown in FIG. 4B, a UI 402 may be presented by the VPN panel 210 for a mobile computing device 100 with WiFi picked as the transport over which the selected VPN configuration will be established. As shown in FIG. 4C, a UI 404 may be presented by the VPN panel 210 for a UMTS mobile computing device 100 with WAN picked as the transport. As shown in FIG. 4D, a UI 406 may be presented by the VPN panel 210 for an EvDO mobile computing device 100 with WAN picked as the transport.

Tips may be presented to explain the “Connect Via:” selector when appropriate. In some embodiments, a WiFi Signal Strength Gadget will be displayed along with the WAN Signal Strength Gadget. In some cases, a VPN connection will be established via general Internet access point name (APN) for a UMTS mobile computing device 100 configured with multiple APN profiles.

If the user selects WiFi when disabled, an alert dialog may be displayed asking the user to Enable WiFi when Connect VPN is selected. If the user confirms, WiFi will be enabled and an MRU-A connect attempt will be made. If WiFi is Enabled but not connected to any network, a WiFi MRU-A connect will be attempted when the user selects Connect VPN.

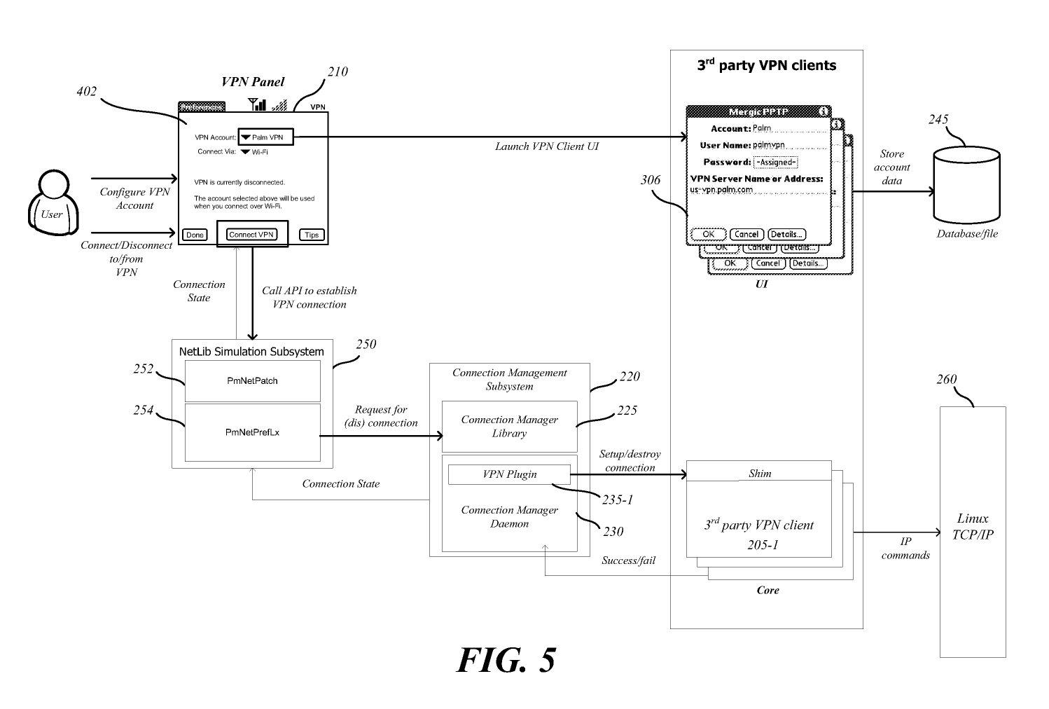

FIG. 5 illustrates one embodiment of a logic diagram, which may be representative of the operations executed by one or more embodiments described herein. In this embodiment, a user configures a VPN account (Palm VPN) via a UI 402 displayed by the VPN panel 210. The VPN panel 210 sends a command to a third party VPN client 205-1 (Mergic PPTP) to launch a VPN client configuration UI 306. When presented with the UI 306, the user may enter account data which may be stored as a configuration profile in the VPN Database 245.

The user may then select connect VPN via the UI 402 displayed by the VPN panel 210. In response, a call API to establish a VPN connection is sent to the simulation subsystem 250 where it is translated from a proprietary OS call (PalmOS call) into an open source call (Linux call) and sent as request for connection (or disconnection) to the connection management subsystem 220. The request is received by the connection manager library 225 and passed to the VPN plug-in module 235-1 implemented by the connection manager 230 (Linux daemon). The VPN plug-in module 235-1 then sends a setup command (destroy command) to the third party VPN client 205-1. The VPN client 205-1 may receive the command via a shim layer which translates the command for the vendor specific interface. The VPN client 205-1 may establish the VPN connection by sending IP commands using a Linux TCP/IP stack 260. The VPN client 205-1 may then report the status of the VPN connection (e.g., success/fail) to the connection manger 230. The connection manger 230 may send the connection state for display by the VPN panel 210 via the simulation subsystem 250.

Various embodiments may comprise, or be implemented as, executable computer program instructions. The executable computer program instructions may be implemented by software, a software module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable storage media in accordance with the described embodiments.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

Although some embodiments may be illustrated and described as comprising exemplary functional components or modules performing various operations, it can be appreciated that such components or modules may be implemented by one or more hardware components, software components, firmware components, and/or combination thereof.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, or any combination thereof.

Some embodiments may be implemented as an article of manufacture comprising a computer-readable storage medium to store executable computer program instructions for performing various operations as described herein. In such embodiments, a computer may include any suitable computer platform, device, system, or the like implemented using any suitable combination of hardware and/or software.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A mobile computing device comprising:
a virtual private network client configured to establish a virtual private network connection over one or more transports; and
a connection manager comprising a virtual private network plug-in module associated with the virtual private network client, the connection manager to load the virtual private network plug-in module in response to a request to establish a virtual private network connection using the virtual private network client over a selected transport, the connection manager to instruct the virtual private network plug-in module to send a setup command to the virtual private network client for establishing the virtual private network connection over the selected transport.

2. The mobile computing device of claim 1, wherein the virtual private network client and the virtual private network plug-in module are provided by a third party developer with respect to the mobile computing device.

3. The mobile computing device of claim 1, wherein the connection manager comprises a daemon having a pluggable framework.

4. The mobile computing device of claim 1, wherein the virtual private network plug-in module comprises a plug-in library.

5. The mobile computing device of claim 1, the virtual private network plug-in module comprising an abstraction layer to configure the virtual private network client.

6. The mobile computing device of claim 1, further comprising multiple virtual private network clients and multiple virtual private network plug-in modules.

7. The mobile computing device of claim 1, wherein the multiple virtual private network clients run simultaneously over different transports.

8. The mobile computing device of claim 1, wherein the virtual private network client is configured to establish a virtual private network connection over multiple transports.

9. The mobile computing device of claim 1, wherein the request to establish a virtual private network connection is received from virtual private network panel.

10. The mobile computing device of claim 1, wherein the request to establish a virtual network connection is received from a data networking application.

11. The mobile computing device of claim 10, wherein the virtual private network client comprises an open source operating system based application and the data networking application comprises a proprietary operating system based application.

12. The mobile computing device of claim 1, the connection manger to detect and initialize compatible virtual private network plug-in modules.

13. The mobile computing device of claim 1, the virtual private network client to communicate virtual private network connection status to the connection manager.

14. The mobile computing device of claim 1, wherein the connection manager comprises one or more transport plug-in modules associated with the one or more transports.

15. A method comprising:
installing a virtual private network client and a virtual private network plug-in module associated with the virtual private network client on a mobile computing device;
receiving a request to establish a virtual private network connection using the virtual private network client over a selected transport;
loading the virtual private network plug-in module in response to the request; and
instructing the virtual private network plug-in module to send a setup command to the virtual private network client for establishing the virtual private network connection over the selected transport.

16. The method of claim 15, further comprising launching the virtual private network plug-in module to configure the virtual private connection client.

17. The method of claim 15, further comprising running multiple virtual private network clients simultaneously over different transports.

18. A computer-readable storage medium comprising executable computer program instructions that when executed enable a computing system to:
run a virtual private network client on a mobile computing device;
store a virtual private network plug-in module associated with the virtual private network client on the mobile computing device;
receive a request to establish a virtual private network connection using the virtual private network client over a selected transport;
load the virtual private network plug-in module in response to the request; and
instruct the virtual private network plug-in module to send a setup command to the virtual private network client for establishing the virtual private network connection over the selected transport.

19. The computer-readable storage medium of claim 18, further comprising executable computer program instructions that when executed enable a computing system to launch the virtual private network plug-in module to configure the virtual private connection client.

20. The computer-readable storage medium of claim 18, further comprising executable computer program instructions that when executed enable a computing system to run multiple virtual private network clients simultaneously over different transports.
